(19) United States
(12) Patent Application Publication
(10) Pub. No.: US 2025/0370972 A1
(43) Pub. Date: Dec. 4, 2025

(54) AUTOMATIC ACCURACY CALIBRATION

(71) Applicant: Oracle International Corporation, Redwood Shores, CA (US)

(72) Inventors: Hariharan Lakshmanan, Brisbane, CA (US); Nirav Vyas, Bangalore (IN); Mahendra Maiti, Fremont, CA (US); Agnivo Saha, Belmont, CA (US); Aurosish Mishra, Foster City, CA (US); Shasank Kisan Chavan, Menlo Park, CA (US); Tirthankar Lahiri, Palo Alto, CA (US); Ioannis Alagiannis, Zurich (CH); Vlad Ioan Haprian, Zurich (CH); Akobir Khamidov, Brooklyn, NY (US); Vikas Neelasandra Shankar, Bangalore (IN)

(21) Appl. No.: 19/298,179

(22) Filed: Aug. 13, 2025

Related U.S. Application Data
(63) Continuation-in-part of application No. 18/885,640, filed on Sep. 14, 2024.
(60) Provisional application No. 63/583,259, filed on Sep. 16, 2023.

(51) Int. Cl. G06F 16/215; G06F 16/22

(52) U.S. Cl. CPC G06F 16/215; G06F 16/2237

(57) ABSTRACT

Techniques for automatically calibration the accuracy of vector queries is provided. In one technique, a vector query that includes a query vector and that is associated with an accuracy value is received. The accuracy value may be a percentage value. In response to receiving the vector query, a value for a vector search parameter is determined based on the accuracy value and a plurality of past accuracy scores. For IVF vector indexes, the vector search parameter may be a number of centroid partitions to scan during the search. For HNSW vector indexes, the vector search parameter value may be a size of a results heap. A search of a vector index is performed based on the query vector and the value for the vector search parameter. A set of results is generated based on the search of the vector index.

### BENEFIT CLAIM

This application claims the benefit as a continuation-in-part of application Ser. No. 18/885,640, filed Sep. 14, 2024, by Mishra et al., the entire contents of which is hereby incorporated by reference, which claims the benefit under 35 U.S.C. §119(e) of provisional application 63/583,259, filed Sep. 16, 2023, by Lahiri et al., the entire contents of which is hereby incorporated by reference.

### TECHNICAL FIELD

The present disclosure relates to vector queries and, more particularly to, automatically adjusting search parameters of a vector index search based on a target accuracy associated with a vector query.

### BACKGROUND

A vector is a fixed length sequence of numbers, typically floating point numbers, such as [21.4, 45.2, 675.34, 19.4, 83.24], which is a five-dimensional vector. An embedding is a means of representing objects (e.g., text, images, and audio) as points in a continuous vector space where the locations of those points in space are semantically meaningful to one or more machine learning (ML) algorithms. An embedding is often represented as a vector. Generically, a vector embedding represents a point in N-dimensional space. Vector embeddings are intended to capture the important “features” of the data that the vector embeddings represent (or embed). The data a vector embedding represents can be one of many types of data, such as a document, an email, an image, or a video. Examples of features are color, size, category, location, texture, meaning, and concept. Each feature is represented by one or more numbers (dimensions) in the vector embedding. Hereinafter, a “vector embedding” is referred to as a “vector.”

Today, vectors are often generated by machine-learned models (e.g., neural networks) and the features they represent are often difficult for humans to understand. One way that vectors are produced by neural networks is by capturing the outputs of the neurons in the penultimate layer, i.e., the neural network's outputs just before the final processing layer.

### Distance Between Vectors

An important attribute of vectors is that the distance between two vectors is a good proxy for the similarity of the objects represented by the vectors. Two vectors that represent similar data should be a short distance from each other in vector space. The opposite is also true: dissimilar data are represented by vectors that are far apart from each other in the vector space. For example, the distance between a vector for the word “cat” and a vector for the word “dog” should be less than the distance the vector for the word “cat” and a vector for the word “plant.”

The distance between two vectors may be calculated by summing the squares of the difference between the numbers in each position of the vectors (which is one similarity measure, referred to as Euclidean distance, among multiple similarity measures):

$$( Vector 1 [ 1 ] - Vector 2 [ 1 ] ) \hat{} 2 + ( Vector 1 [ 2 ] - Vector 2 [ 2 ] ) \hat{} 2 + …$$

The property that vector distance represents object similarity is what allows similar data to be found using a vector database. For example, when a vector representing a picture of a dog is searched for in a vector database, the nearest vectors will be those representing other dogs, not vectors representing plants.

### Vector Processing Workloads

Vector processing workloads (not to be confused with SIMD vector processing) have been used in Natural Language Processing (NLP), image recognition, recommendations, etc. Vector processing workloads have two sub-categories that require separate optimization strategies: indexing and searching. Regarding indexing, vector embeddings (or simply vectors) are indexed using approximate indexing techniques. Unlike B-tree indexes, a vector index returns many matching values ranked by similarity. Index creation and rebuild tend to be CPU intensive and are optimized for throughput.

Regarding searching, the stored vectors are searched using a class of algorithms known as “Similarity Search” or “Approximate Nearest Neighbor (ANN)” to find the closest vectors to a query vector. Search is designed to minimize CPU usage in order to minimize response time.

### Vector Processing Patterns

A vector similarity search is like interactive online transaction processing (OLTP) in that end-users submit vector queries and expect an instant reply. Vector similarity search requires millisecond response time to finding vectors that are close (represent similar data) even when the database in which the vectors are stored holds billions of vectors. An example query is “find products that are similar to this picture” [reference to a digital image].” Another example query is “find corporate documents that conceptually match this natural language prompt: [NL prompt].”

Providing fast response times requires using specialized vector indexes and fast algorithms for computing distances between vectors. In some use cases, there is a need to combine vector similarity search with relational data. For example, a query may ask for data about houses that match a natural language prompt, are valued at over $1M, are in zip code 94070, and whose owner recently declared bankruptcy. Also, there may be a need to be able to insert new vectors into a database, delete vectors from the database, and index the vectors in real time.

### Vector Databases

Early vector workloads often used flat files or object stores to store vectors. An application would read the vectors out of their backend repositories into memory and perform vector processing using third-party libraries, such as FAISS. Generative artificial intelligence (AI) has greatly increased the volume and processing needs for vectors. Generative AI requires support for much higher volume ingest and faster filtering and retrieval. A database with vector capabilities and built-in indexing is important for these applications.

### Vector Indexes

Currently, similarity searches are often performed on data sets with billions of vectors (i.e., vector embeddings). For example, the Deep1B dataset contains 1 billion images generated by a Convolutional Neural Network (CNN). Computing VECTOR_DISTANCE with every vector in the corpus to find Top-K matches at 100% accuracy is very slow. As a result, vector indexes are used to trade-off search quality (recall/accuracy) for search speed.

Vector indexes tend to group data based on vector similarity with the search restricted to a few groups, achieving significant data pruning. Vector similarity is defined in terms of vector distance calculations. A goal is for a vector index to fit in memory (as opposed to only in slower, long-term (e.g., non-volatile) storage, such as disk) to allow for fast traversals and scans. With modern techniques and memory capacities, an index for billions of vectors can fit into volatile memory.

Two types of vector indexes that may be used to index vectors include Hierarchical Navigable Small Worlds Index (HNSW) and Inverted File Index (IVF). HNSW is an in-memory graph that is fast and relatively accurate, but it is larger in size than IVF. IVF is slower and less accurate, but it is smaller in size. (The relative accuracies of HNSW indexes and IVF indexes are generally true if default, or “out-of-the-box,” search parameters are used.) Product Quantization (PQ) is a lossy compression technique that may be used to reduce the size of a vector index so that the index may fit into memory or be scanned faster. However, a tradeoff of PQ is lower accuracy. HNSW and IVF may be combined (with or without PQ) to optimize both speed and size.

Vector indexes are approximate by design. Using a vector index means that the searcher is willing to trade 100% accuracy for faster response times. Accuracy may be defined as the number of Top K matches that are returned by a vector index and that are also present in the Top K matches that are returned by an exact table scan. For example, if a search of a vector index returns a Top 5 result of {ID1, ID2, ID4, ID5, ID6} and the table scan returns a Top 5 result of {ID1, ID2, ID3, ID4, ID5}, then the index is missing one match: ID3, and hence, the accuracy is 4 out of 5, or 80%.

Current vector indexes are associated with creation parameters and search parameters that affect the accuracy of the results that are returned from a search of the vector indexes. Depending on the values chosen for those parameters, the accuracy of search results from traversing a vector index vary greatly. Current vector indexes tend to provide (1) highly accurate results even though the entity that initiates the vector query is not requesting that level of accuracy and (2) insufficiently accurate results when the needs of the entity require it. Even if a vector index achieves a certain level of accuracy and a certain level of latency at one time, such as at time of creation of the vector index, the levels of accuracy and latency may change significantly over time due to changes in workload and changes in the distribution of the data (e.g., as a result of inserts and/or deletes).

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example vector database management system, in an embodiment;

FIG. 2 is a diagram that depicts an example set of five clusters that is generated based on a clustering algorithm, in an embodiment;

FIG. 3 is a diagram that depicts a subset of clusters that are selected based on distance calculations between a query vector and centroids in the clusters;

FIG. 4 is a diagram that depicts an example logical representation of an HNSW index that comprises four layers, in an embodiment;

FIG. 5 is a flow diagram that depicts an example process for processing a vector query with an associated accuracy value, in an embodiment;

FIG. 6 is a block diagram that illustrates a computer system upon which an embodiment of the invention may be implemented;

FIG. 7 is a block diagram of a basic software system that may be employed for controlling the operation of the computer system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method for processing a vector query that specifies an accuracy value. In one technique, in response to receiving such a vector query, it is determined, based on the specified accuracy value and past accuracy scores, a value for a vector search parameter. A search of a vector index is performed based on the query vector and the value for the vector search parameter. A set of results is generated based on the search of the vector index.

Embodiments improve computer-related technology pertaining to vector query processing, adjusting vector index searches based on user-specified target accuracies. Therefore, in instances where a user does not require relatively accurate results and speed is more important, the user may specify a relatively low target accuracy and, as a result, search of the vector index will have relatively low latency. Conversely, in instances where a user requires relatively accurate results and speed is not as important, the user may specify a relatively high target accuracy and, as a result, the results of the search of the vector index will have high accuracy.

### Vector Database System Overview

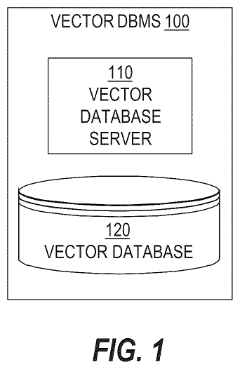

FIG. 1 is a block diagram that depicts an example vector database management system (VDBMS) 100, in an embodiment. VDBMS 100 comprises a vector database server 110 and a vector database 120. Vector database server 110 is communicatively coupled to vector database 120. VDBMS 100 may be deployed in a network of an enterprise or may be deployed in a cloud environment and, therefore, may be accessible to an enterprise over one or more computer networks (e.g., the Internet). VDBMS 100 may be provisioned for an enterprise by a cloud management team of a cloud provider as needed on an enterprise-by-enterprise basis.

Vector database server 110 comprises one or more computing machines, each executing one or more compute instances that receive and process data requests, including data retrieval requests (e.g., queries) and data modification requests (i.e., for vector data modifications), such as inserting vectors, deleting vectors, and updating vectors. A computing instance translates a data request into a storage layer request that the computing instance transmits to vector database 120. A computing machine that hosts at least one compute instance includes (1) one or more processors, (2) volatile memory for storing data requests (and their respective contents) and vector data that is retrieved from vector database 120, and (3) optionally, non-volatile memory.

Vector database 120 may comprise multiple storage devices, each storing vector data and, optionally, one or more non-vector data. For example, vector database 120 stores a table that includes a column for storing vectors and one or more column for storing user data, such as a column for storing a user identifier, a column for storing a user profile, a column for storing user search history, a column for storing user access history, a column for storing user-generated content, etc. In this example, each row in the table corresponds to a user, such as a customer, a subscriber to a service, etc.

Vector database 120 may also store one or more indexes that index content in vector database 120, such as content stored in one or more base tables. Some of the indexed content may be vector-related data (e.g., actual vector embeddings and metadata thereof) and some of the indexed content may be non-vector-related data, such as content in columns that do not store vectors. Thus, at least one index that vector database 120 may store is a vector index, described in more detail herein.

### Vector Queries

A “vector query” is a query that targets one or more vectors in a vector database, such as vector database 120. Vector database server 110 receives a vector query, generates an execution plan for the vector query, and processes the execution plan in order to retrieve one or more vectors from vector database 120. A vector query typically includes a “query vector” and, optionally, one or more other search criteria. A query vector is a vector that vector database server 110 uses to identify one or more vectors in vector database 120. Examples of one or more other search criteria include dates, numbers, strings, etc. For example, a vector query may ask for the top five matching vectors that are associated with the state of California and a date range between Feb. 1, 2024 and Mar. 5, 2024. Such other search criteria may comprise data from columns that are part of the same table that includes the vector column that stores the vectors that the vector query targets.

In order to identify vectors that are similar to a query vector, vector database server 110 may compare the query vector to each vector stored in vector database 120. However, comparing a query vector to each vector in vector database 120 may take a significant amount of time that users are not willing to wait in order to receive an answer. Also, performing such a naïve scan of vector database 120 given a query vector may require a significant amount of computer resources that could be used for other tasks. To address these problems, a vector index may be generated and used in query vector processing.

### Vector Index: IVF

An IVF index is based on K-means clustering or partitioning. A K-means clustering algorithm is applied to a set of vectors to generate K partitions. The value of K (or the number of partitions) may be based on the number of vectors. For example, K=sqrt(N), where N is the number of vectors. Each partition is identified by a centroid, which is a value that is conceptually the average of the vectors that are assigned to that partition. The centroid of a partition may be considered the “center of gravity” of the partition. A goal in determining a centroid is to minimize a total distance between vectors within a partition and their centroid, so that each centroid is a good representative value for its partition.

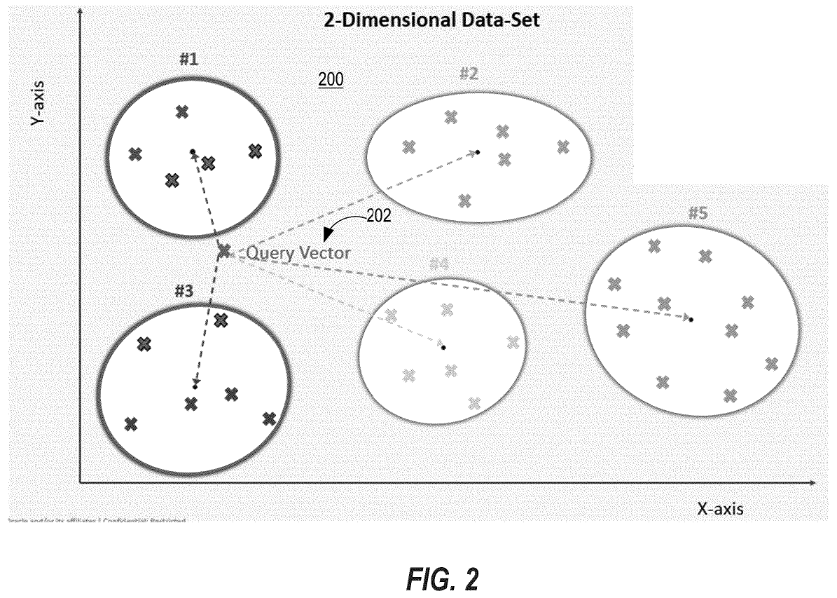

FIG. 2 is a diagram that depicts an example set of five clusters 200 that is generated based on a clustering algorithm, in an embodiment. In this example, vectors are two-dimensional and, therefore, may be mapped onto a two-dimensional plane with an X-axis and a Y-axis. However, some vectors may have hundreds of dimensions. FIG. 2 also depicts a query vector 202 that is not in any of the five clusters 200.

An IVF index comprises two types of tables: (1) a centroid table that stores all the centroids of all the partitions; and (2) K partition tables, each of which stores the vectors that are assigned to that corresponding partition based on closeness to the centroid represented by the partition. In a similarity search, given query vector 202, the centroid table is searched first (referred to as the “first-level search”) to identify one or more centroids that are the most similar to (or has the lowest distance to) query vector 202. Thus, either only a single centroid is selected from the centroid table or multiple centroids are selected from the centroid table. The number of centroids to select may be a default value (e.g., two) and/or may be based on vector distance from the query vector. (For example, select the closest three centroids that are within D vector distance from the query vector.) In the example of FIG. 2, a vector distance calculation is performed for each pair of vectors, each pair comprising query vector 202 and a different centroid of clusters 200. Because there are five clusters 200, five pairs are considered and five distance calculations are performed.

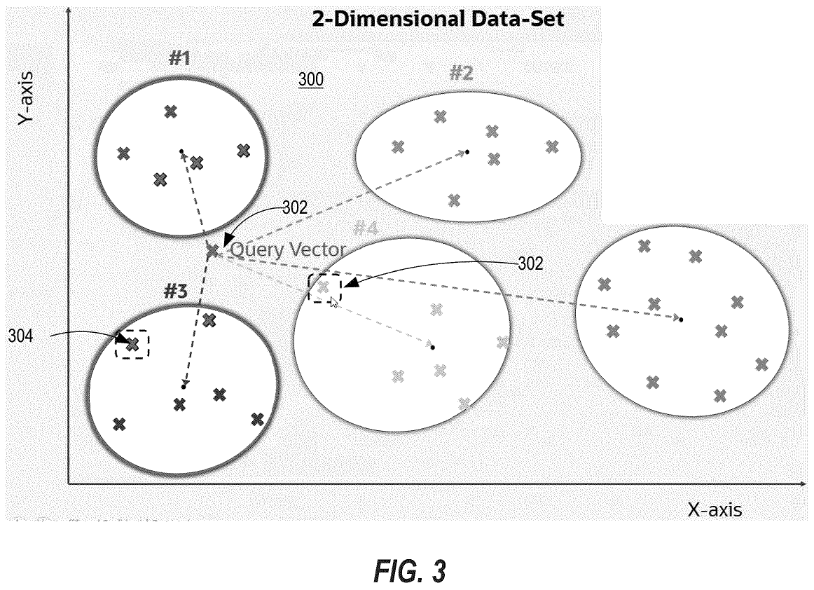

FIG. 3 is a diagram that depicts a subset of clusters that are selected based on distance calculations between query vector 202 and centroids in clusters 200. In this example, two clusters are selected, which may be due to a threshold distance that each distance between a query vector and a corresponding centroid must be under in order to be considered a candidate cluster to search. Additionally or alternatively, two clusters are selected due to a pre-defined number of centroids to select (“n-probe”). In this example, the centroids in clusters #1 and #3 are selected from among the five centroids in clusters 200. However, because cluster #4 is not part of the second-level search, vector 302 cannot be considered a candidate vector. Also, vector 304 can be selected as a candidate vector, even though vector 302 is closer to query vector 202 than vector 304.

Then, for each selected centroid, the partition to which that identified centroid belongs is searched to identify one or more vectors. This search is referred to as a “second-level search.” If the query vector is for the Top K, then the Top K vectors in each identified partition are identified and then the Top K from the Top K of each identified partition are selected. Even if the query vector is closer to a centroid associated with one partition, the closest vector to the query vector may be in another partition. Thus, searching one partition might not be sufficient for an accurate search; searching multiple partitions is generally prudent.

However, in an embodiment, the closer that a query vector is to the closest centroid, the fewer partitions are considered in the second-level search. A measurement of closeness of a query vector to the closest centroid may be based on one or more distances between the query vector and one or more vectors in the partition of the closest centroid and/or one or more other centroids. For example, if a query vector is over three times closer to the closest centroid than to a particular centroid, then the partition that corresponds to the particular centroid is not searched in the second-level search, neither any partition whose centroid is farther from the query vector than the particular centroid. As another example, if a query vector is closer to the closest centroid than the query vector is to over 50% of the vectors in the partition that corresponds to that centroid, then no other partition is searched.

### Vector Index: HNSW

HNSW is a multi-layer in-memory graph index that has relatively high speed and accuracy relative to IVF and other vector indexes. The graph index comprises vertices, each vertex corresponding to a vector. The lowest layer of the graph contains vertices of all of the vectors in the indexed data set. Higher layers of the HNSW index have a decaying fraction of the vertices in the layer below. In each layer, vertices are connected to their approximate M closest neighbors using edges that are used to walk the graph. At the lowest layer (“layer 0”), the number of neighbors of each vertex may be different than the number of neighbors of each vertex at higher layers, such as 2M. The vertices at higher layers are on average much farther from each other (relative to lower layers) and, therefore, allow traversal of long distances.

Two major parameters for HNSW index construction are M and R. “M” is referred to as the “neighbor count” and is the number of neighbors that each vertex is connected to on each layer. Layer 0 (the lowest layer) may have double that number (e.g., 2M neighbors). A probability distribution function may be defined based on M in order to determine whether a vertex is to be inserted in a layer that is above the lowest layer. The probability distribution function is such that probabilities decay with higher layers. When the probability drops below 1e−9, then no more layers are added. An example probability distribution function is

$$p ( Layer ) = ( 1 - 1 / M ) / M \hat{} layer$$

Regarding parameter R, when a new vertex (corresponding to a new vector) is inserted into an HNSW index, a random number R between [0.0, 1.0] is generated. A new vertex is always inserted into layer 0. A new vertex is inserted into higher layers up to layer “i” if:

$$R > p ( i - 1 ) + p ( i - 2 ) … + p ( 0 )$$

In an example, with M=10, if R=0.991, then the new vertex is inserted in layers 0 and 1.

An HNSW parameter that is used only for construction is referred to as “efConstruction” and refers to the number of vertices to consider within a layer when looking for the closest M vertices (or closest 2M vertices in layer 0) to which to connect a new vertex. Larger values for this parameter improve index quality but slow down construction. An example value for this parameter is 2M (or 4M for layer 0).

An HNSW parameter that is used in searching is referred to as “efSearch” and refers to the number of vertices to remember in each layer when searching for the K nearest neighbors in a top-K search. Larger values of this parameter improve search quality but slow down searches. An example value for this parameter is 2*K (or double the number of desired K matches).

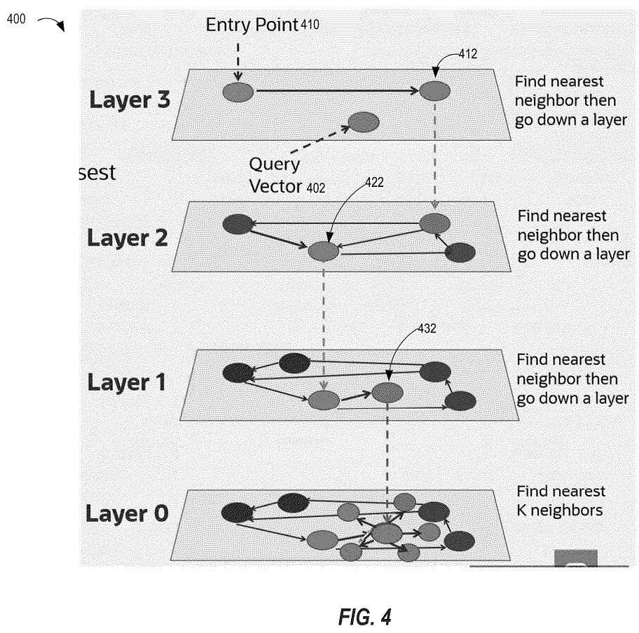

FIG. 4 is a diagram that depicts an example logical representation of an HNSW index 400 that comprises four layers, in an embodiment. An index search begins from an entry vertex 410 in the top layer (layer 3) and traverses edges looking for the vertex, in that layer, whose vector is nearest query vector 402. If M is 32, then 33 distance calculations are performed between query vector 402 and (i) the vertex of entry vector 410 and (ii) 32 neighbors of entry vector 410. The search process does not only consider neighbors of the entry vector 410, the search process finds the closest neighbor and computes distances for its neighbors as well. This process continues until all the neighbors of a vertex are further from the query vector than the vertex that was used to arrive in that neighborhood. Once the closest vector to query vector 402 in a layer is found (i.e., vertex 412 in this example), the search continues starting with that vertex in the next layer down. This process repeats for each intermediate layer of HNSW index 400. (Thus, vertex 422 is selected in layer 2 and vertex 432 is selected in layer 1.) The index search completes in the lowest layer (i.e., layer 0) by considering the (e.g., 2M) neighbors of vertex 432, in the lowest layer, whose vectors are closest to query vector 402.

For traversing the lowest layer, two heaps are maintained: a candidates heap and a Top K heap. The candidates heap stores vertices that are candidates for further exploration and are ordered based on distance to the query vector. The Top K heap stores the current best Top K result set so far. The Top K heap holds efSearch vertices. The search proceeds as follows. Vertex 432 is at the top of the candidates heap and all its 2M neighbors are below it in the candidates heap, ordered by distance to query vector 402. Vertex 432 is selected and compared against all vertices in the Top K heap (which is initially empty). The goal is to check whether a vertex popped from the candidates heap can beat the worst vertex (in terms of distance to the query vector) from the Top K heap (which is also a priority queue ordered in reverse, i.e. furthest vertex among the efSearch vertices is at the top of the Top K heap). If the best candidate vertex beats the worst vertex from the current Top K heap, then the best candidate vertex is added to the to the Top K heap and the worst vertex is removed from the Top K heap. The search continues, meaning more candidates are explored. When vertex 432 is selected, the Top K heap is empty, so vertex 432 is automatically added to the Top K heap.

In a scenario where the Top K heap is full (i.e., it contains efSearch vertices), when a vertex V is selected from the candidates heap, the worst vertex in the Top K heap is replaced by V if V beats that worst vertex. All neighbors of V are then added to candidates heap and ordered within the candidates heap, and the next best vertex in the candidates heap is selected and the search continues. The search terminates if the current best candidate in the candidates heap cannot beat the worst vertex in the Top K heap. Increasing efSearch gives us accuracy because it is more likely for a candidate vertex to be better than the worst vertex in a set of one hundred vertices in the Top K heap than for the candidate vertex to be better than the worst vertex in a set of ten vertices. Thus, with larger values of efSearch, the exploration goes on longer.

### Target Accuracy

Current approaches for providing approximate search results do not allow for users to specify a target accuracy in their respective vector queries. Thus, users must accept the accuracy that current vector indexes support.

In an embodiment, a user of a vector index specifies a target accuracy of one or more vector queries that the user submits. For example, a user may specify a target accuracy as part of a vector query that is submitted to VDBMS 100. As another example, a user may establish a target accuracy for all vector queries that the user submits to VDBMS 100 or all vector queries that the user submits in a particular database session; thus, different database sessions may be associated with different target accuracies. Thus, the user only needs to specify this target accuracy once and that target accuracy is automatically applied by VDBMS 100 to subsequent vector queries that the user (or his/her organization) submits to VDBMS 100 (e.g., in the same session or across multiple sessions). As another example, a user specifies a target accuracy for each of different classes or categories of vector queries. Thereafter, a vector query that is submitted is associated with one of these classes or categories. VDBMS 100 determines the class/category of the vector query and then looks up the target accuracy for that class/category.

This embodiment allows accuracy to be chosen based on use case. For example, a law enforcement “person of interest” match needs high accuracy; thus, a slower response time is acceptable. In contrast, finding related items while shopping online can be less accurate in order to obtain a faster response time.

### Mapping From Target Accuracy to Search Parameter Value

In an embodiment, a mapping is generated that maps (or associates) a target accuracy to a search parameter value associated with a vector index. In the IVF context, the search parameter is number of probes (“nprobes”), meaning the number of clusters (or centroid partitions) that will be scanned. The higher the number of clusters, the more vectors are considered. In the HNSW context, the search parameter is size of the Top-K heap (“efSearch”). The higher the value of this size, the greater the number of vertices that are explored. The mapping may include multiple entries, each entry associating an accuracy value with a search parameter value. Some entries may correspond to the same sampled vector, but different top K values. Thus, the mapping may also associate a top K value with the accuracy value-search parameter value pair. Therefore, in one implementation, a vector index is searched multiple times given a sampled vector, but with different values of K.

The mapping is automatically generated based on an automatic analysis of the performance (in terms of accuracy) of multiple vectors against the vector index. Given a mapping and a target accuracy that is associated with a particular vector query, the mapping is consulted with the target accuracy and a search parameter value (that is associated with the target accuracy) is identified. The vector index is then searched, using the identified search parameter value, to identify indexed vectors that are closest to the query vector of the particular vector query.

The vectors that are selected for traversing the vector index in order to produce the mapping may be sampled from one or more sources. For example, query vectors that VDBMS 100 has received in past vector queries may be stored for later analysis to generate the mapping. As another example, random vectors that are indexed by the vector index may be used to generate the mapping. An advantage of sampling query vectors from past vector queries is that future query vectors are likely to have a similar data distribution as the past query vectors and, therefore, the mapping is more likely to be more accurate than randomly sampling indexed vectors. However, the latter approach of randomly sampling indexed vectors is useful when the vector index is newly generated/built and relatively few (if any) query vectors have been searched for via the vector index.

To generate the mapping, for each sampled vector, the vector index is traversed at least once with the sampled vector. An accuracy of a vector index given a sampled vector may be determined by comparing (1) the search results of traversing a vector index (using the sampled vector) given a search parameter value with (2) the search results of scanning the base table. An example value of the accuracy of a vector index is, given a vector and a value of K, the percentage of the items in (2) that are also found in (1). For a given vector, different values of K may be associated with different accuracies. For example, the accuracy of a vector index given a sampled vector may decrease as the value of K increases if the value of nprobes or efSearch remains the same.

In a related embodiment, the search results of (2) may be approximated by having a relatively high search parameter value. For example, in the IVF context, the search parameter value may be 90% of the partitions in the centroid partitions table. In the HNSW context, the search parameter value may be 256 or 512.

In a related embodiment, instead of associating an accuracy value with a search parameter value, an accuracy bucket is associated with a search parameter value. An accuracy bucket is a range of accuracy values. For example, if an accuracy value is 83, then the accuracy value is assigned an accuracy bucket whose range of accuracy values includes 83, such as 80-85. Examples of other accuracy buckets include 75-80 and 86-90. Different accuracy buckets may have different ranges. For example, lower valued accuracy values (e.g., 34) may be associated with “large” accuracy buckets (e.g., 25-40), in terms of the size of the range, while higher-valued accuracy values (e.g., 91) may be associated with “small” accuracy buckets (e.g., 90-93).

In an embodiment, a mapping is a table with multiple columns and multiple rows (entries). Columns for the table include vector ID, search parameter, minimum accuracy, maximum accuracy, and Top-K. Together, minimum accuracy and maximum accuracy reflect a bucket. If the table stores accuracy data for multiple vector indexes, then the table may have an additional column for vector index ID that uniquely identifies the vector index that was traversed using the associated search parameter value.

### Process Overview

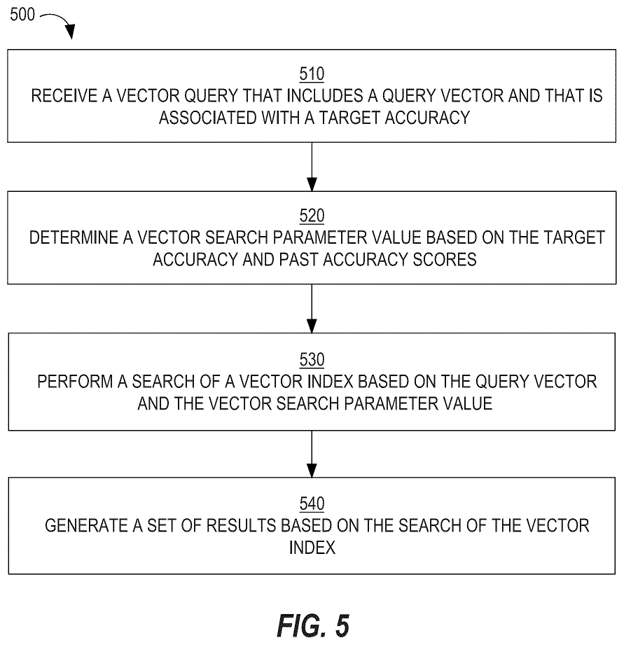

FIG. 5 is a flow diagram that depicts an example process 500 for processing a vector query with an associated accuracy value, in an embodiment. Process 500 may be performed by one or more components of VDBMS 100.

At block 510, a vector query that includes a query vector and that is associated with an accuracy value is received. This accuracy value is the target accuracy of the vector query. The vector query may specify the accuracy value or it may be associated with the vector query in another way.

At block 520, in response to receiving the vector query, a value for a vector search parameter is determined based on the accuracy value and past accuracy scores. In the IVF context, the vector search parameter is number of probes, while, in the HNSW context, the vector search parameter is a size of a result heap. To be conservative on the accuracy, the value of the vector search parameter may be one or more numbers higher than what is returned from analyzing the past accuracy scores. Block 520 may also involve taking into account the value of K (if the vector query is a Top-K query) when determining the value for the vector search parameter.

At block 530, a search of a vector index is performed based on the query vector and the value for the vector search parameter. The higher the value of the vector search parameter, the higher the latency of the search.

At block 540, a set of results is generated based on the search of the vector index. If the vector query is a top-K query and the vector query specified a value for K, then the number of results in the set of results is K or less. Block 540 may involve transmitting the set of results to a client device that submitted the vector query.

### Using the Mapping to Identify a Search Parameter Value

In an embodiment, given a mapping and a target accuracy of a vector query, a search parameter value is determined. The mapping may be searched for all entries that include the target accuracy. If the mapping stores accuracy buckets instead of single accuracy values, then one or more entries are identified that include an accuracy bucket into which the target accuracy falls.

If there are multiple of such entries, then a set of search parameter values may be identified. To be conservative, the highest search parameter value in the set of search parameter values is selected. This gives the highest likelihood (relative to the other search parameter values in the set) of achieving the target accuracy. However, the highest search parameter is most likely to be associated with the highest latency relative to the other search parameter values in the set. Conversely, the lowest search parameter value in the set of search parameter values may be selected. This gives the lowest likelihood (relative to the other search parameter values in the set) of achieving the target accuracy. However, the lowest search parameter is most likely to be associated with the lowest latency relative to the other search parameter values in the set.

In a related embodiment, a search parameter value is identified that reflects a probability of achieving the target accuracy. For example, 85% may be selected as a default probability, meaning that, given the set of search parameter values, the identified search parameter value has a 85% chance of achieving the target accuracy. The identified search parameter value may be a search parameter value in the set of search parameter values. Alternatively, the identified search parameter value might not be in the set of search parameter values. Such a search parameter value may be selected based on one or more computations involving the other search parameter values in the set. For example, a set of search parameter values for a particular target accuracy is {4, 5, 5, 7}. A median selection technique would yield 5. A mode selection technique would also yield 5. An average selection technique would yield 21/4=5.25, which could translate to 5 or 6, depending on implementation. A percentile selection technique, if the percentile is 75%, would yield 5 (since 75% of all the search parameter values are 5 or less); if the percentile is 35%, would yield 5 (since 4 is 25% percentile and 5 is 50%-75% percentile); if the percentile is higher than 75%, then that would yield 7 or 6, depending on the implementation.

In a related embodiment where the mapping includes a Top-K value (or range of Top-K values) for each accuracy value-search parameter value association, the search parameter value is determined, for a vector query, based on a Top-K value that is associated with (e.g., specified by) the vector query. This Top-K value may limit the number of search parameter values to consider when selecting a search parameter value for processing the vector query. For example, in response to receiving a vector query that is associated with a target accuracy (whether specified by the vector query or otherwise associated with the vector query) and a Top-K value, the mapping is analyzed to identify all entries that have (1) the Top-K value (or a Top-K range that includes the Top-K value of the vector query) and (2) an accuracy bucket whose range includes the target accuracy.

In a related embodiment, a function is automatically learned based on analyzing the mapping. An input to the function (or independent variable) is target accuracy (and, optionally, top-K value) and output of the function (or dependent variable) is search parameter value. Another possible input may be a probability value that indicates an estimated probability that the vector index will achieve the target accuracy. Any technique for automatically learning a function based on the mapping may be used.

In an embodiment, a mapping is re-generated (or replaced with a new mapping) in response to one or more mapping generation criteria being satisfied. Examples of mapping generation criteria include a complete and/or partial rebuild of the vector index, the passage of a certain period of time (e.g., two days) since the current mapping was generated, the number of changes that have been made relative to indexed vectors (e.g., inserts, deletes, or updates) since the current mapping was generated, and query latency thresholds being exceeded at a certain frequency or in a certain percentage of vector queries since the current mapping was generated.

In a related embodiment, a mapping is constantly changing as older statistics age out and new statistics are added to the mapping. For example, associations (between accuracy and search parameter value) that were made over 72 hours ago are automatically deleted from the mapping while new associations that are generated are added to the mapping.

### Optimizations to Generate the Mapping

Naively executing vectors against a vector index in order to generate associations between accuracies of the vector index and search parameter values may consume a significant amount of computer resources, such as CPU, volatile memory, network, and/or persistent storage. In other words, the cost of generating the mapping may exceed the benefits of searching a vector index with appropriate search parameter values.

In an embodiment, in order to generate an accuracy value of a vector index given a vector, a golden set is computed. A golden set of a vector refers to a result set that gives either an exact answer for the vector or an approximate answer for a vector. The golden set may be approximated by traversing just a portion of the vector index. For example, in the HNSW context, a HNSW index is traversed with a given vector and a relatively high value for the efSearch parameter is used, such as 512. This will give a relatively accurate (e.g., 99% accurate) golden set. As another example, in the IVF context, a centroids table is scanned to identify the top (e.g., 50% or 75% of) centroids and only the vectors assigned to the corresponding centroid partitions are scanned in order to generate a golden set. Thus, generating the golden set does not require scanning the base table.

In a related embodiment, generating a golden set of a vector involves performing a scan of a base table upon which the vector index is built. In this embodiment, the golden set is exact, not approximate. In this embodiment, a matrix multiplication operation is performed that involves computing a vector distance between the (e.g., query) vector and a subset of vectors in the base table. The matrix multiplication operation may be a batch operation that involves inputting, into the operation, multiple (e.g., 256) vectors in a single performance of the operation. In this way, the golden set is computed quickly and efficiently, without traversing the vector index. Even compared to an approach that involves accessing the base table directly in order to compute a golden set, using matrix multiplication is much faster.

In a related embodiment, a matrix multiplication operation computes vector distances for a plurality of sample query vectors and a subset of vectors of the base table. Thus, the golden set may be computed for many sample query vectors in a single operation.

In an embodiment involving IVF indexes, instead of traversing an IVF index multiple times given a single vector in order to determine an accuracy value of different values of the number of centroid partitions search parameter, the IVF index is traversed once and an accuracy is computed after each centroid partition. Specifically, the centroids table is scanned and vector distance is computed between the query vector and each centroid vector. Such a vector distance computation may be performed using relatively few matrix multiplication (batch) operations, as described herein. The computed vector distances are used to order the centroid vectors in descending order, i.e., with the centroid vector having the shortest vector distance in the first position, the centroid vector having the second shortest vector distance in the second position, and so forth. The centroid partitions in the centroid partitions table are scanned in the order corresponding to the order of the centroid vectors. After (1) the first centroid partition is scanned (and a vector distance is computed for each vector in the first centroid partition; e.g., using batch vector distance computation), (2) a search result is generated that involves ordering the vector distances of the first centroid partition, (3) the top K of those vector distances is determined, and (4) a number of those top K results that appear in the golden set for the sampled vector is determined. That number is used to calculate an accuracy of the IVF index given the sampled vector. This accuracy value, the number of centroid partitions scanned thus far (i.e., the search parameter value) (which is ‘1’ for the first centroid partition), and, optionally, the top K value, are stored in the mapping.

For example, the first centroid partition is scanned using sample query vector, resulting in the following vector distances being computed: VD₁, VD₂, . . . VD_{N}. Each vector distance is associated with a different vector from the first centroid partition. The vector distances (VD₁-VD_{N}) are then ordered from closest (in terms of similarity) to the sample query vector to least similar to the sample query vector. One or more top K results are generated based on this ordering. For example, the top 5 are identified, the top 10 are identified, the top 30 are identified, and the top 100 are identified. Each top K result may include a set of vector identifiers (from the first centroids table) or a set of vector distances that are associated with the corresponding vector identifiers. For example, the top 5 may be {v23, v8, v312, v97, v68}. Each generated top K result is then checked to see how many vectors in the top K result are found in the corresponding golden set for the sample query vector.

Steps (1)-(4) are repeated for each centroid partition, but instead of the first centroid partition being scanned again, the next (ordered) centroid partition is scanned. Also, step (2) involves generating a search result that is based on the most recently scanned centroid partition and previous centroid partition scans given the sampled vector.

In an embodiment, if the accuracy reaches a ratio of 1/1 or 100% (meaning an exact match) and not all centroid partitions have been scanned, then any remaining centroid partitions that have not yet been scanned may be skipped, thus saving computing resources on scanning those centroid partitions and analyzing results of that scanning.

In a related embodiment, instead of waiting until the accuracy reaches 100%, scanning ceases when the accuracy reaches a certain threshold (e.g., 98%), which may be considered sufficient for determining an accurate number of centroid partitions to scan given a target accuracy for a query vector.

In a related embodiment to the steps (1)-(4) embodiment, instead of scanning the centroids table to generate a vector distance for each sampled vector-centroid pair and then scanning each centroid partition in order, the vector distances that were computed for the golden set are re-used. The golden set may have been generated naively or efficiently using the matrix multiplication operation. The golden set is ordered based on vector distance and includes, for each indexed vector in the golden set, a cluster identifier to which the indexed vector is assigned in the IVF index. An example mapping that associates (i) the position of an indexed vector (based on vector distance relative to other vector distances of other indexed vectors to the sampled vector) with (ii) cluster ID of the indexed vector is as follows:

TABLE A

| Position | Cluster ID |
|---|---|
| 1 | 4 |
| 2 | 4 |
| 3 | 8 |
| 4 | 7 |
| 5 | 4 |

The centroids table is also scanned to generate vector distances between each centroid vector and the sampled vector. The computed vector distances are ordered in descending order, which effectively orders the cluster IDs of the centroids, each cluster ID uniquely identifying a centroid vector and a centroid partition in the centroid partitions table. An ordered list of centroids, given the example in Table A, may be 4, 7, 12, 8, etc. With this ordered set of centroids and the ordered list of cluster IDs in Table A, accuracy scores may be computed for each consecutive positive integer for the search parameter, number of centroid partitions to scan. For example, the first cluster ID in the ordered list of cluster IDs is 4. Given a top K value for a query vector, a number of the first K values in the Cluster ID column that has a 4 is computed and then divided by K, which output is a measure of accuracy. This accuracy and the value of 1 (indicating the search parameter value) is reflected in the mapping that maps accuracy to search parameter values. Then, the second cluster ID in the ordered list of cluster IDs is identified, which is 7, in this example. The number of the first K values in the Cluster ID column that has a 4 or a 7 is computed and then divided by K, which output is another measure of accuracy. This accuracy and the value of 2 (indicating the search parameter value) is reflected in the mapping that maps accuracy to search parameter values. This process continues for each cluster ID in the ordered list of cluster IDs until the accuracy measure is 1/1 or 100%.

In a related embodiment, this process of efficiently generating a mapping between accuracy values and their corresponding search parameter values may be repeated for different values of K. For example, a first mapping between a set of accuracy values and their corresponding search parameter values is computed for a top K value of 10, then a second mapping between another set of accuracy values and their corresponding search parameter values is computed for a top K value of 20, and so forth.

In a related embodiment, while computing an accuracy of a vector index given a sampled vector, after the golden set is generated and the indexed vectors in the golden set are ordered in descending order by vector distance to the sampled vector, for each number of probes that is tested for accuracy, multiple values of top K are also tested for computing accuracies. (This is where the vector index is an IVF index.) For example, if there are five top K values to be tested {10, 30, 50, 75, 100}, then, while number of probes is two, an accuracy is computed for the top 100, then an accuracy is computed for the top 75, and so forth until an accuracy is computed for the top 10. Then, the number of probes is increased to three and the process repeats for each of the five top K values.

In an embodiment where the vector index is an HNSW index, different values of the efSearch parameter are tested and, for each value of the efSearch parameter that is tested, multiple values of top K are also tested for computing accuracies. For example, if there are five top K values to be tested {10, 30, 50, 75, 100}, then, while the efSearch parameter is 16, an accuracy is computed for the top 100, then an accuracy is computed for the top 75, and so forth until an accuracy is computed for the top 10. Then, the efSearch parameter is increased to 32 and the process repeats for each of the five top K values.

In an embodiment where the mapping is a set of multiple accuracy scores for multiple sampled vectors, to decrease the time to identify a search parameter value for a query vector given a target accuracy associated with the query vector, the mapping may be analyzed for each accuracy bucket and a search parameter value determined for each accuracy bucket. In other words, a final association between a single accuracy bucket and one or more search parameter value may be pre-computed (i.e., before a vector query arrives) by analyzing the mapping. Thus, an analysis of the mapping in response to receiving each vector query may be avoided. Each accuracy bucket may be associated with multiple search parameter values. From the multiple search parameter values, a likelihood (or range of likelihoods) may be generated for each search parameter value. For example, the accuracy bucket of 50%-60% may be associated with search parameter values of {3, 3, 4, 6} in the original mapping (using, for example, four entries in the original mapping) and in a “final association” that includes a single entry for this accuracy bucket. Thereafter, if a target accuracy is 55%, then the final association is searched for an entry associated with an accuracy range that includes the target accuracy, and, depending on default or user-configurable parameters, one of these search parameter values is selected, or at least a value between the highest and lowest values in this range, such as 5. If the likelihood parameter value is 75%, then 4 is selected as the search parameter value. If the likelihood parameter value is 50%, then 3 is selected as the search parameter value.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

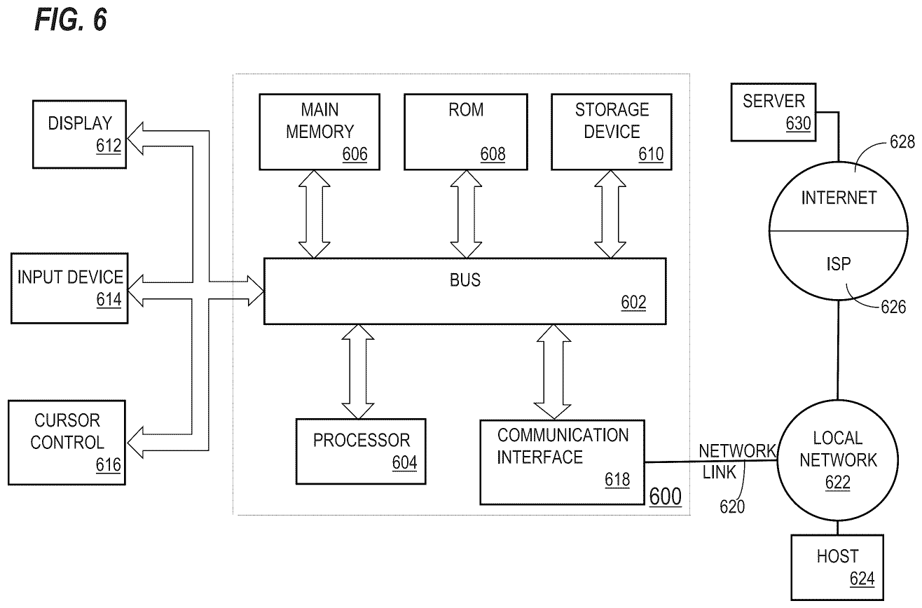

For example, FIG. 6 is a block diagram that illustrates a computer system 600 upon which an embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or solid-state drive is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 610. Volatile media includes dynamic memory, such as main memory 606. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic, or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the worldwide packet data communication network now commonly referred to as the “Internet” 628. Local network 622 and Internet 628 both use electrical, electromagnetic, or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### Software Overview

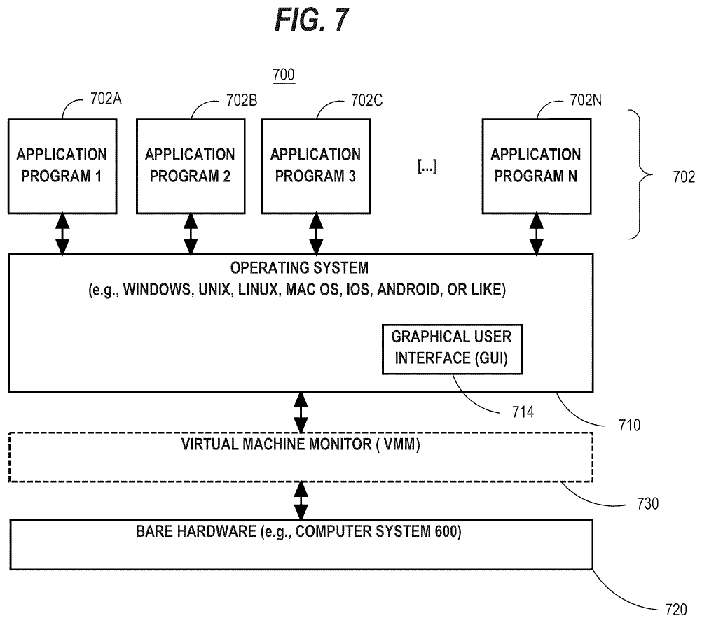

FIG. 7 is a block diagram of a basic software system 700 that may be employed for controlling the operation of computer system 600. Software system 700 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 700 is provided for directing the operation of computer system 600. Software system 700, which may be stored in system memory (RAM) 606 and on fixed storage (e.g., hard disk or flash memory) 610, includes a kernel or operating system (OS) 710.

The OS 710 manages low-level aspects of computer operation, including managing execution of processes, memory allocation, file input and output (I/O), and device I/O. One or more application programs, represented as 702A, 702B, 702C . . . 702N, may be “loaded” (e.g., transferred from fixed storage 610 into memory 606) for execution by the system 700. The applications or other software intended for use on computer system 600 may also be stored as a set of downloadable computer-executable instructions, for example, for downloading and installation from an Internet location (e.g., a Web server, an app store, or other online service).

Software system 700 includes a graphical user interface (GUI) 715, for receiving user commands and data in a graphical (e.g., “point-and-click” or “touch gesture”) fashion. These inputs, in turn, may be acted upon by the system 700 in accordance with instructions from operating system 710 and/or application(s) 702. The GUI 715 also serves to display the results of operation from the OS 710 and application(s) 702, whereupon the user may supply additional inputs or terminate the session (e.g., log off).

OS 710 can execute directly on the bare hardware 720 (e.g., processor(s) 604) of computer system 600. Alternatively, a hypervisor or virtual machine monitor (VMM) 730 may be interposed between the bare hardware 720 and the OS 710. In this configuration, VMM 730 acts as a software “cushion” or virtualization layer between the OS 710 and the bare hardware 720 of the computer system 600.

VMM 730 instantiates and runs one or more virtual machine instances (“guest machines”). Each guest machine comprises a “guest” operating system, such as OS 710, and one or more applications, such as application(s) 702, designed to execute on the guest operating system. The VMM 730 presents the guest operating systems with a virtual operating platform and manages the execution of the guest operating systems.

In some instances, the VMM 730 may allow a guest operating system to run as if it is running on the bare hardware 720 of computer system 600 directly. In these instances, the same version of the guest operating system configured to execute on the bare hardware 720 directly may also execute on VMM 730 without modification or reconfiguration. In other words, VMM 730 may provide full hardware and CPU virtualization to a guest operating system in some instances.

In other instances, a guest operating system may be specially designed or configured to execute on VMM 730 for efficiency. In these instances, the guest operating system is “aware” that it executes on a virtual machine monitor. In other words, VMM 730 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

The above-described basic computer hardware and software is presented for purposes of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
receiving a vector query that includes a query vector and that is associated with an accuracy value;
in response to receiving the vector query:
determining, based on the accuracy value and a plurality of past accuracy scores, a value for a vector search parameter;
performing a search of a vector index based on the query vector and the value for the vector search parameter;
generating a set of results based on the search of the vector index;
wherein the method is performed by one or more computing devices.

2. The method of claim 1, wherein the accuracy value is a percentage value.

3. The method of claim 1, wherein the value for the vector search parameter is a number of centroid partitions of an IVF index to scan during the search.

4. The method of claim 1, wherein the vector query specifies a Top-K value, wherein determining the value for the vector search parameter is further based on the Top-K value.

5. The method of claim 1, further comprising, prior to receiving the vector query:
selecting a plurality of vectors;
for each vector of the plurality of vectors:
performing a particular search of the vector index based on said each vector;
generating a particular set of results based on the particular search;
generating an accuracy score of the particular set of results;
storing an association between the accuracy score and a search parameter value that was used during the particular search;
including the association in a set of associations;
wherein determining the value for the vector search parameter is further based on the set of associations.

6. The method of claim 5, further comprising:
storing a plurality of query vectors from a plurality of vector queries;
wherein selecting the plurality of vectors comprises sampling the plurality of query vectors;
wherein a subset of the vectors in the plurality of vectors originate from the plurality of query vectors.

7. The method of claim 5, wherein selecting the plurality of vectors comprises randomly sampling vectors that are indexed by the vector index.

8. The method of claim 5, wherein performing the particular search of the vector index based on said each vector comprises:
generating a plurality of vector distance values, each vector distance value reflecting a vector distance between said each vector and a different indexed vector of a plurality of indexed vectors in the vector index;
generating a data structure comprising a plurality of entries, each entry for storing an association between an indicator of the plurality of indexed vectors and a cluster identifier to which the indexed vector corresponding to the indicator is assigned;
storing, in the data structure, indicators of the plurality of indexed vectors in an order that is based on an order of the plurality of vector distance values;
for each indicator of the indicators, storing, in the data structure, a cluster identifier to which the indexed vector that corresponds to said each indicator is assigned;
ordering a set of centroids in the vector index based on vector distances between the set of centroids and the query vector.

9. The method of claim 8, further comprising:
for each centroid in the ordered set of centroids:
identifying, based on the data structure and a cluster identifier associated with said each centroid, a set of results that would be generated if one or more centroid partitions that correspond to said each centroid and any preceding centroids were searched in a search of the vector index.

10. The method of claim 1, wherein the vector query specifies the accuracy value or the accuracy value is associated with an entity that submitted the vector query.

11. The method of claim 1, wherein the vector index is an HNSW index and the vector search parameter value is a size of a results heap.

12. The method of claim 1, further comprising:
based on the plurality of past accuracy scores, generating a machine-learned model using one or more machine learning techniques;
wherein determining the value for the vector search parameter comprises inputting the accuracy value into the machine-learned model, which outputs the value based on the accuracy value.

13. One or more non-transitory storage media storing instructions which, when executed by one or more computing devices, cause:
receiving a vector query that includes a query vector and that is associated with an accuracy value;
in response to receiving the vector query:
determining, based on the accuracy value and a plurality of past accuracy scores, a value for a vector search parameter;
performing a search of a vector index based on the query vector and the value for the vector search parameter;
generating a set of results based on the search of the vector index.

14. The one or more non-transitory storage media of claim 13, wherein the accuracy value is a percentage value.

15. The one or more non-transitory storage media of claim 13, wherein the vector query specifies a Top-K value, wherein determining the value for the vector search parameter is further based on the Top-K value.

16. The one or more non-transitory storage media of claim 13, wherein the instructions, when executed by the one or more computing devices, further cause, prior to receiving the vector query:
selecting a plurality of vectors;
for each vector of the plurality of vectors:
performing a particular search of the vector index based on said each vector;
generating a particular set of results based on the particular search;
generating an accuracy score of the particular set of results;
storing an association between the accuracy score and a search parameter value that was used during the particular search;
including the association in a set of associations;
wherein determining the value for the vector search parameter is further based on the set of associations.

17. The one or more non-transitory storage media of claim 16, wherein the instructions, when executed by the one or more computing devices, further cause:
storing a plurality of query vectors from a plurality of vector queries;
wherein selecting the plurality of vectors comprises sampling the plurality of query vectors;
wherein a subset of the vectors in the plurality of vectors originate from the plurality of query vectors.

18. The one or more non-transitory storage media of claim 16, wherein performing the particular search of the vector index based on said each vector comprises:
generating a plurality of vector distance values, each vector distance value reflecting a vector distance between said each vector and a different indexed vector of a plurality of indexed vectors in the vector index;
generating a data structure comprising a plurality of entries, each entry for storing an association between an indicator of the plurality of indexed vectors and a cluster identifier to which the indexed vector corresponding to the indicator is assigned;
storing, in the data structure, indicators of the plurality of indexed vectors in an order that is based on an order of the plurality of vector distance values;
for each indicator of the indicators, storing, in the data structure, a cluster identifier to which the indexed vector that corresponds to said each indicator is assigned;
ordering a set of centroids in the vector index based on vector distances between the set of centroids and the query vector.

19. The one or more non-transitory storage media of claim 18, wherein the instructions, when executed by the one or more computing devices, further cause:
for each centroid in the ordered set of centroids:
identifying, based on the data structure and a cluster identifier associated with said each centroid, a set of results that would be generated if one or more centroid partitions that correspond to said each centroid and any preceding centroids were searched in a search of the vector index.

20. The one or more non-transitory storage media of claim 13, wherein the vector query specifies the accuracy value or the accuracy value is associated with an entity that submitted the vector query.
